(19) United States
(12) Patent Application Publication
(10) Pub. No.: US 2025/0247493 A1
(43) Pub. Date: Jul. 31, 2025

(54) RENDERING IMAGE CONTENT

(71) Applicant: Mo-Sys Engineering Limited, London (GB)

(72) Inventors: Michael Paul Alexander Geissler, London (GB); James Uren, London (GB)

(73) Assignee: Mo-Sys Engineering Limited, London, EN (GB)

(21) Appl. No.: 18/687,193

(22) PCT Filed: Aug. 25, 2022
(86) PCT No.: PCT/GB2022/052191

§ 371 Date: Feb. 27, 2024

(30) Foreign Application Priority Data
Aug. 27, 2021 (GB) 2112327.8

(51) Int. Cl. H04N 5/272; H04N 5/268

(52) U.S. Cl. CPC H04N 5/272; H04N 5/268

(57) ABSTRACT

A control system for controlling a display screen forming a background to a video set wherein multiple cameras are available to capture video of a subject against the screen and an output selector is configured to receive captured video streams from the cameras and select the stream from a determined one of those cameras as its output, the control system comprising a display controller configured to compute an image of a background scene from the point of view of a camera other than the determined one of the cameras.

This invention relates to rendering image content, for example video content.

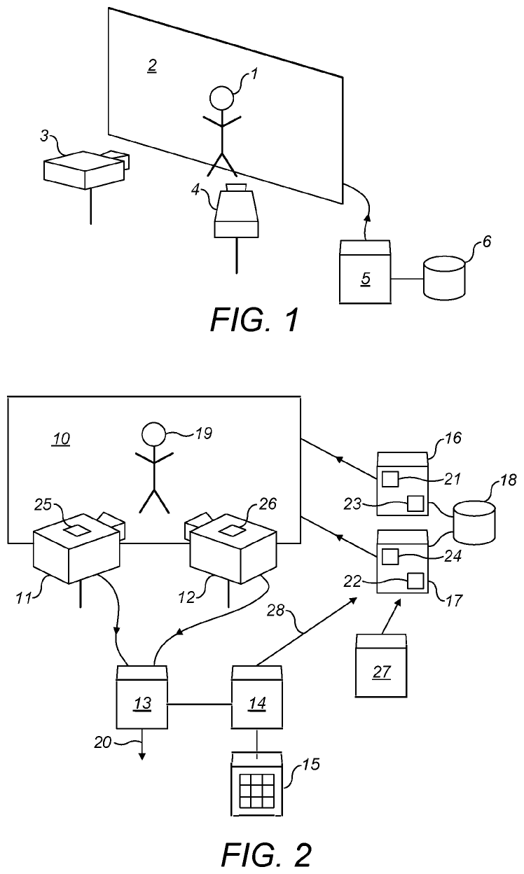

FIG. 1 shows an arrangement for recording video. A subject 1 is in front of a display screen 2. Multiple cameras 3, 4 are located so as to view the subject against the screen. A display controller 5 can control the display of images on the screen. These may be still or moving images which serve as a background behind the subject. This setup provides an economical way to generate video content with complex backgrounds. Instead of the background being built as a traditional physical set it can be computer generated and displayed on the screen.

When the background represents a three-dimensional scene, with depth, the image displayed on the screen should be displayed with a suitable transformation so that it appears realistic from the point of view of the camera. This is usually achieved by a render engine implemented in display controller 5. The render engine has access to a datastore 6 which stores three-dimensional locations of the objects to be represented in the background scene. The render engine then calculates the position and appearance of those objects as they would be seen from the point of view of the active camera, for instance camera 3. The results of that calculation are used to form the output to the display screen 2. When filming switches to another camera, for instance camera 4, the render engine re-calculates the background image as it would be seen from the point of view of that camera.

A problem with this arrangement is that whilst the switching or cutting between cameras can be achieved very quickly, it can take time for the render engine to re-calculate the scene from the perspective of the new camera, especially if the scene is complex. This can result in a lag in the background scene changing when there is a cut from one camera to another. Even if that lag is very short, it can result in an undesirable shifting effect in the video captured by the new camera, which can make the background seem unconvincing compared to the results from a traditional physical set. This issue occurs even when the visible frustums of the cameras intersect.

There is a need to improve the rendering of background images when there is a change in the viewpoint of the active camera.

According to one aspect of the present invention there is provided a control system for controlling a display screen forming a background to a video set. Multiple cameras are available to capture video of a subject against the screen. An output selector is configured to receive captured video streams from the cameras and select the stream from a determined one of those cameras as its output. The control system comprises a display controller configured to compute an image of a background scene from the point of view of a camera other than the determined one of the cameras.

The image of the background scene from the point of view of the camera may be computed whilst the video stream from the determined one of the cameras is output for display on the display screen. In other words, the image of the background scene from the point of view of the camera may be computed whilst the determined one of the cameras is active.

According to a second aspect of the present invention there is provided a video capture system for capturing video in a set comprising a display screen providing a background and wherein multiple cameras are available to capture video of a subject against the screen. The system comprises an output selector configured to receive captured video streams from the cameras and select the stream from a determined one of those cameras as its output; and a display controller configured to compute an image of a background scene from the point of view of a camera other than the determined one of the cameras.

The image of the background scene from the point of view of the camera may be computed whilst the video stream from the determined one of the cameras is output for display on the display screen. In other words, the image of the background scene from the point of view of the camera may be computed whilst the determined one of the cameras is active.

The display controller may be configured to provide the image to the screen for display in response to the designation of the output of the other camera for selection by the output selector.

The video capture system may comprise a user input device for receiving input from a user, wherein that input may represent the said designation of the output of the other camera.

The video capture system may comprise multiple display controllers, wherein each display controller may be assigned to compute an image of the background scene from the point of view of respective one of the cameras.

The video capture system may comprise fewer display controllers than the number of the cameras.

Each display controller may be configured to, when it is not providing image output to the screen and it is signalled with the identity of a camera whose stream is to be selected as output, compute an image of the background scene from the point of view of that camera.

The video capture system may comprise a camera selection controller which may be configured to: receive an input representing the designation of a camera to provide output; signal the identity of that camera to one or more of the display controllers; and a predetermined time after such signalling, may cause that display controller to provide image output to the screen and cause the output selector to select the stream from that camera as its output.

The video capture system may comprise a camera selection controller configured to: receive an input representing the designation of a camera to provide output; signal the identity of that camera to one or more of the display controllers; and in response to a signal from a display controller indicating that a background image from the point of view of that camera is available, cause that display controller to provide image output to the screen and cause the output selector to select the stream from that camera as its output.

According to third aspect of the present invention there is provided a render engine controller, the controller being configured to: receive an indication of the location of a first camera with respect to a display wall, wherein the first film camera is currently filming a shot; receive an indication of the location of a second film camera with respect to the display wall to which the shot is going to switch next; the controller being configured to output the location of the first film camera to a first render engine of the plurality of render engines, and output the location of the second film camera to a second render engine of the plurality of render engines; each render engine being configured to prepare a respective rendered image for displaying on the display wall in dependence on the location received by each render engine respectively; the controller being configured to selectively connect the first and second render engines to a display controller for displaying the image rendered by the connected render engine on the display wall.

The controller may be configured to connect a render engine to the display controller if that render engine is receiving an output from the controller that indicates the location of the film camera that is being used to film a (current) shot.

The controller may be configured not to connect a render engine to the display controller if that render engine receives an output from the controller that indicates the location of a film camera to which the shot is going to switch.

The controller may be configured to be connected to fewer render engines than there are film cameras in use.

The controller may be configured to delay a switch from one camera to another if it is determined that the frustums of those cameras intersect, and otherwise to not delay such a switch.

According to a fourth aspect of the present invention there is provided a system comprising a plurality of film cameras directed at a display wall and a plurality of render engines, each render engine being configured to receive an input relating to the position of one of the plurality of film cameras with respect to the display wall, wherein each render engine is configured to output a rendered image in dependence on the position received by each render engine, and wherein the number of render engines is less than the number of film cameras.

According to a fifth aspect of the present invention, there is provided a method of video capture in a set comprising multiple cameras and a display screen providing a background, the method comprising:
capturing multiple video streams of a subject against the display screen from multiple respective cameras;
outputting a first one of the captured video streams from a first one of the cameras for display on the display screen;
computing, whilst the first one of the captured video streams is output for display on the display screen, an image of a background scene from the point of view of a second camera of the multiple cameras.

The second camera may be a camera of the multiple cameras which is not being used for output to the display at the time that the image is being computed. In other words, the second camera may be a camera that is not currently active.

There is disclosed a method of video capture comprising the equivalent features of the systems described above.

The system may comprise a render engine controller for controlling the plurality of render engines, and a display controller for receiving a rendered image and outputting the rendered image to the display wall. The render engine controller may be configured to prevent each render engine from the plurality of render engines from outputting a rendered image to the display controller.

The term “film camera” will be used to refer to a camera capable of capturing video regardless of the medium on which the video is recorded. The camera itself may record the video on internal digital memory or may transmit the captured video to a remote device for recordal.

The render engine controller may be configured to receive an input that indicates a requested film camera that has been selected for filming the next shot of the display wall, and an input that indicates the active film camera that is being used to film the current shot of the display wall. For example, the active camera may be “camera 3”, which is in current use. The requested camera may be “camera 4”, to which the shot is going to switch next. The background image shown on the display screen is adapted for the viewpoint of the active camera, e.g., “camera 3”. The requested camera becomes the active camera once the switch has occurred. For example, once the shot has switch to camera 4 and is in current use.

The render engine controller may allow only the render engine rendering the image for the active film camera (the film camera in current use) to output an image to the display controller.

The render engine may send the location of the requested film camera (the film camera to be used in the next shot) to a render engine for preparing the image in advance.

FIG. 2 shows an arrangement for recording video. The arrangement comprises a display screen 10, multiple video cameras 11, 12, a video feed switch 13, a camera selector unit 14, a camera selector user interface 15, multiple display controllers 16, 17 and a scene database 18. The arrangement is not confined to the specific set up as shown in FIG. 2, for example, the camera selector unit 14 and/or video feed switch 13 may be a part of the display controllers 16.

The display screen 10 is controllable to display a desired scene. It may be a front- or back-projection screen, or a light emissive screen such as an LED wall. It may be made up of multiple sub-units such as individual frameless displays butted together. It may be planar, curved or of any other suitable shape.

A subject 19 is in front of the screen, so that the subject can be viewed against an image displayed on the screen. That is, with the image displayed on the screen as a background to the subject. The subject may be an actor, an inanimate object or any other item that is desired to be videoed. Typically, the subject is free to move in front of the screen.

The outputs from each camera, representing video data streams, pass to the video feed switch 13. This selects a single one of the incoming video data streams for output at 20. The stream is selected in dependence on a signal from the camera selector unit 14, which operates under the control of user interface 15. Thus, by operating the user interface 15, and operator can cause a selected one of the incoming video streams captured by the cameras to be output. In this way the operator can cut or request to cut between the two cameras.

Each display controller comprises a processor 21, 22 and a memory 23, 24. Each memory stores in non-transitory form instructions executable by the respective processor to cause the processor to provide the respective display controller with the functions as described herein. In practice, the two display controllers may be substantially identical.

Each display controller has access to the scene database 18. The scene database stores information from which the display controllers can generate images of a desired scene from a given point of view to allow such images to be displayed on the screen 10. In one example, the scene database may store one or more images that can be subject to transformations (e.g. trapezoidal transformations and/or scaling transformations) by the display controllers to adapt the stored images to a representation of how the scenes they depict may appear from different points of view. The transformations may take into account the distortion induced by the lens currently installed in the camera, the pan/tilt attitude of the camera and any offset of the camera image plane from a datum location of the camera. Transformations to deal with these issues are known in the literature. In another example, the scene database may store data defining the appearance of multiple objects and those objects' placement in three dimensions in one or more scenes. With this data the display controllers can calculate the appearance of the collection of objects from a given point of view. Again, the transformations may take into account the distortion induced by the lens currently installed in the camera, the pan/tilt attitude of the camera and any offset of the camera image plane from a datum location of the camera. To achieve the required processing the display controllers may implement a three-dimensional rendering engine. An example of such an engine is Unreal Engine available from Epic Games, Inc.

Cameras may be capable of operating with interchangeable lenses. Which lens is currently fitted to the camera will affect the camera's field of view. This may be taken into account automatically with knowledge of which lens is fitted to the camera. The lens may communicate with the camera to report its identity and/or optical characteristics. The camera or a device capable of communicating with it may receive data from the lens and estimate the camera's frustum or field of view. This estimated field of view can then be used as described herein.

A display controller may be continuously active but may output control data to the screen only when it determines itself to be operational to control the screen. When a display controller is outputting data to the screen, the screen displays that data as an image.

Thus, each display controller 16, 17 has a processor running code stored in the respective memory. That code causes the respective display controller to retrieve data from the memory 18 and to form an image of a scene using that data and the location of a given point of view. Then, when the controller is operational to control the screen it outputs that image to the screen, which displays the image.

The image displayed by the screen may be a still image or a video image. When a subject is in front of the screen, the use of a video image allows the background to vary during the course of a presentation by the subject that is being recorded by the cameras. The video image may, for example, portray falling rain, moving leaves, flying birds or other background motion.

An operator may determine the locations of the cameras 11, 12 before videoing starts and provide that data to the display controllers for use as point-of-view locations. Alternatively, each camera may be provided with a location estimating device 25, 26 that estimates the location of the camera in the studio or other environment where filming is taking place. That device may, for example, be a StarTracker sensor/processor system as is commercially available from the applicant. Such a device can allow the location of the camera to be tracked as the camera moves. Location data determined by such a device can be passed to the display controllers for use as point of view locations. These are just examples of mechanisms whereby the display controllers can receive the locations of the cameras. Once the display controllers have the location of the cameras 11, 12 they can use that information as point of view locations from which to estimate the appearance of a scene. FIG. 2 shows a camera location estimation unit 27, which could form part of a StarTracker system. That unit communicates wirelessly with the devices 25, 26 to learn the cameras' locations and provides those locations to the display controllers 16, 17. To determine the frustum of each camera, data relating to the camera lens may be provided to the display controller. For example, this data may be the zoom of the camera, the width of the shot, the width of the lens itself, and any other details relating to the specification of the type of lens in use.

In a first example, each display controller is configured to correspond to a respective one of the cameras. Each display controller computes a scene from the point of view of the camera to which it corresponds. It may do that continuously so that at any time it can output the scene as it would appear from the location of its corresponding camera. A user may set up the display controllers in advance by designating which camera each one should correspond to, or the display controllers may establish that automatically. In this example each display controller computes the scene from the point of view of only a single camera. It does so whether or not that camera is the currently selected camera (selected by units 14 and/or 15) that is providing the ultimate output at 20. It makes its computations on the basis of the location of the respective camera either as originally provided to it or as received in real time from a camera position estimator.

An output 28 passes from the camera selector unit 14 to the display controllers. This provides the display controllers with information about which camera is selected to be active. When the camera to which a particular display controller corresponds is active, that display controller provides its computed scene as output to the screen. Otherwise, it does not provide a scene as output to the screen. In an alternative arrangement, both display controllers may provide output simultaneously to a switch which selects one of those outputs to pass to the screen. The switch is controlled by the signal at 28. A switch box may be positioned between display controllers 16 and 17 which receives the output 28 indicating which camera is active and can switch the input to the display screen 10 between the two controllers. That is, the switch box sits between the input to the display screen and the display controllers. The switch box receives the outputs of both the display controllers and also receives the output 28. In dependence on the output 28, the switch box decides which display controller output to allow as the input to the display screen, and allows that output as input to the display screen. In the situation where a switch box controls the input to the display screen 10, it may be desirable to position the switch box close to the display screen. That may reduce latency.

Suppose display controller 16 corresponds to camera 11 and display controller 17 corresponds to camera 12. In operation, when camera 11 is filming the subject 19 against the screen 10, the screen is displaying output from display controller 16. When the operator of console 15 selects to cut to camera 12, selector 14 signals switch 13 to select the feed from camera 12 and signals the display controllers or another switch to swap the screen to be controlled by display controller 17. The switching of video feeds by switch 13 is substantially instantaneous. Similarly, the switching of screen 10 to displaying an image from the point of view of camera 12 can be substantially instantaneous because display controller 17 was computing the scene from the point of view of the newly feeding camera 12 before the switch between cameras was made. There was no need for a display controller to compute a new scene in response to the switch between cameras. This can improve the quality of the video output by reducing and/or removing any lag before the screen displays the scene from the point of view of the newly selected camera.

The system as described above can be extended to three or more cameras by providing one display controller per camera.

In practice, it may be preferable to provide fewer display controllers than there are cameras. This may be done in the manner of a second embodiment.

In the second embodiment there need only be two display controllers irrespective of the number of cameras. Each display controller receives and/or stores information on the locations of all the cameras. Suppose the cameras are designated A, B and C and the display controllers are designated X and Y. Initially camera A and display controller X are active. Display controller X is calculating a scene from the point of view of camera A and causing the screen to display that scene. When a cut from camera A to, say, camera B is to be made, that is signalled to the currently inactive display controller prior to the cut being implemented in the output video stream at 20. The mechanism for this will be described in more detail below. In response to being signalled as to an upcoming cut to a currently inactive camera (B), the currently inactive display controller (Y) starts to compute the scene from the point of view of that camera. Then, when the cut in the video feed is subsequently made, that display controller becomes active and controls the display. This may be done by the display controllers changing which one is providing output, or through a switch of the type described above. This makes the previously active display controller now inactive. The inactive display controller is available to compute a scene in a similar way for the next camera (e.g. camera C) to become active.

One approach to signalling the display controllers in advance as to the active camera is for the operator of the user interface 15 to provide a first input to designate the next camera to become active, and then to provide a second input to designate that that camera is to become active. Another approach is for the camera selector to automatically implement a delay after receiving an input to designate a camera as active before that camera is actually made active. In one arrangement the delay may be pre-programmed as being a period sufficient for a display controller to generate a scene. In this arrangement, the sequence of events is:
i. The operator provides an input to the user interface 15 to designate a newly selected camera. This input is passed to the camera selector 14.
ii. The camera selector starts a timer, and outputs the identity of the newly selected camera to at least the currently inactive display controller.
iii. The inactive display controller starts computing a scene from the point of view of the newly selected camera.
iv. When the timer reaches the predetermined value the camera selector signals the switch 13 to switch video feeds so that from the newly selected camera is forming the output at 20 and also signals the display controllers and/or another switch to cause the previously inactive display controller to become active and control the screen.

If the currently inactive display controller can indicate when it has rendered the scene from the point of view of the newly selected camera then in some circumstances it may be possible to reduce the time taken for switching, as follows:
i. The operator provides an input to the user interface 15 to designate a newly selected camera. This is passed to the camera selector 14.
ii. The camera outputs the identity of the newly selected timer to at least the currently inactive display controller.
iii. The inactive display controller starts computing a scene from the point of view of the newly selected camera. When that scene is ready to be displayed that display controller signals that state to the camera selector.
iv. In response to that signal the camera selector signals the switch 13 to switch video feeds so that from the newly select camera is forming the output at 20 and also signals the display controllers and/or another switch to cause the previously inactive display controller to become active and control the screen. It will be appreciated that in other architectures the switching of the output signals and the signals to the screen could be performed directly by one of the display controllers.

In these arrangements the operator only needs to perform a single operation to select the new camera.

In the arrangements described above selection of which camera is to provide output is performed manually. It could be done automatically by means of an algorithm that analyses the video output by each camera and estimates which forms the best output at any time. Or the system could cycle through the cameras on a predetermined schedule.

The cut from one camera to another may be performed with no delay, i.e. effectively immediately, or after a delay. In one arrangement the system may identify whether the frustums of the current camera and the camera to be cut to intersect. If they do not intersect then the system may determine to perform the cut immediately. If they do intersect then the system may optionally delay the cut.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A control system for controlling a display screen forming a background to a video set wherein multiple cameras are available to capture video of a subject against the screen and an output selector is configured to receive captured video streams from the cameras and select the stream from a determined one of those cameras as its output, the control system comprising a display controller configured to compute an image of a background scene from the point of view of a camera other than the determined one of the cameras.

2. A video capture system for capturing video in a set comprising a display screen providing a background and wherein multiple cameras are available to capture video of a subject against the screen, the system comprising:
an output selector configured to receive captured video streams from the cameras and select the stream from a determined one of those cameras as its output; and
a display controller configured to compute an image of a background scene from the point of view of a camera other than the determined one of the cameras.

3. A video capture system as claimed in claim 2, wherein the display controller is configured to provide the image to the screen for display in response to the designation of the output of the other camera for selection by the output selector.

4. A video capture system as claimed in claim 2, comprising a user input device for receiving input from a user, that input representing the said designation of the output of the other camera.

5. A video capture system as claimed in claim 2, comprising multiple display controllers, each display controller being assigned to compute an image of the background scene from the point of view of respective one of the cameras.

6. A video capture system as claimed in claim 2, comprising fewer display controllers than the number of the cameras.

7. A video capture system as claimed in claim 6, wherein each display controller is configured to, when it is not providing image output to the screen and it is signalled with the identity of a camera whose stream is to be selected as output, compute an image of the background scene from the point of view of that camera.

8. A video capture system as claimed in claim 6, comprising a camera selection controller configured to:
receive an input representing the designation of a camera to provide output;
signal the identity of that camera to one or more of the display controllers; and
a predetermined time after such signalling, cause that display controller to provide image output to the screen and cause the output selector to select the stream from that camera as its output.

9. A video capture system as claimed in claim 6, comprising a camera selection controller configured to:
receive an input representing the designation of a camera to provide output;
signal the identity of that camera to one or more of the display controllers; and
in response to a signal from a display controller indicating that a background image from the point of view of that camera is available, cause that display controller to provide image output to the screen and cause the output selector to select the stream from that camera as its output.

10. A render engine controller, the controller being configured to:
receive an indication of the location of a first camera with respect to a display wall, wherein the first film camera is currently filming a shot,
receive an indication of the location of a second film camera with respect to the display wall to which the shot is going to switch next,
the controller being configured to output the location of the first film camera to a first render engine of the plurality of render engines, and output the location of the second film camera to a second render engine of the plurality of render engines,
each render engine being configured to prepare a respective rendered image for displaying on the display wall in dependence on the location received by each render engine respectively;
the controller being configured to selectively connect the first and second render engines to a display controller for displaying the image rendered by the connected render engine on the display wall.

11. A render engine controller as claimed in claim 10, the controller being configured to connect a render engine to the display controller if that render engine is receiving an output from the controller that indicates the location of the film camera that is being used to film a (current) shot.

12. A render engine controller as claimed in claim 10, the controller being configured not to connect a render engine to the display controller if that render engine receives an output from the controller that indicates the location of a film camera to which the shot is going to switch.

13. The render engine controller as claimed in claim 12, the controller being configured to be connected to fewer render engines than there are film cameras in use.

14. A render engine controller as claimed in claim 10, the controller being configured to delay a switch from one camera to another if it is determined that the frustums of those cameras intersect, and otherwise to not delay such a switch.

15. A system comprising a plurality of film cameras directed at a display wall and a plurality of render engines, each render engine being configured to receive an input relating to the position of one of the plurality of film cameras with respect to the display wall, and wherein each render engine is configured to output a rendered image in dependence on the position received by each render engine; wherein the number of render engines is less than the number of film cameras.

16. A system as claimed in claim 15, further comprising a render engine controller for controlling the plurality of render engines, and a display controller for receiving a rendered image and outputting the rendered image to the display wall, wherein the render engine controller is configured to prevent each render engine from the plurality of render engines from outputting a rendered image to the display controller.
